(19) United States
(12) Patent Application Publication
(10) Pub. No.: US 2004/0261623 A1
(43) Pub. Date: Dec. 30, 2004

(54) Folding griddle

(76) Inventors: Peter Huggler, Columbia, MO (US); David Halterman, Macon, MO (US)

Correspondence Address: Jean C. Edwards, SONNENSCHEIN NATH & ROSENTHAL, Wacker Drive Station, P.O. Box 061080, Chicago, IL, 60606-1080, US

(21) Appl. No.: 10/602,911

(22) Filed: Jun. 25, 2003

(51) Int. Cl. A23L 1/00

(52) U.S. Cl. 99/275

(57) ABSTRACT

A cooking apparatus includes a cooking surface heated by a heating mechanism and divided into two cooking surfaces by a center seam. A mechanism for preventing grease from draining through the center seam may include either a center grease drain, a ridge along the center seam, or a seal. The cooking apparatus is folded using a hinge, along the center seam, such that the cooking surfaces are separated and disposed on external opposite and parallel sides. A control assembly, which may control the griddle surfaces separately, is removably attached to the cooking apparatus and stored at an underside thereof. The control assembly includes a cover to prevent damage to the control elements. At least one channel with a drain hole therein is disposed at each of the cooking surfaces for receiving cooking fluids, and a removable grease tray disposed beneath the drain hole collects the fluids.

The present invention relates to a cooking apparatus in the form of a griddle which can be folded for ease of storage.

### BACKGROUND OF THE INVENTION

Conventional griddles are bulky, and storage of conventional griddles can be difficult since they normally include chamber covers and grease drainage pans disposed underneath the griddles, which are cumbersome when storing on kitchen shelving.

Further, the control assembly or other peripheral equipment, is usually stored separately from the griddle, which is inconvenient for the user.

Accordingly, a griddle which is easy to use, and which can be stored compactly along with all peripheral equipment, is needed.

### SUMMARY OF THE INVENTION

The present invention relates to a cooking apparatus which provides ease of use and can be compactly stored with peripheral equipment.

The cooking apparatus, in one embodiment consistent with the present invention, includes a body having a substantially planar cooking surface heated by a heating mechanism and divided into two cooking surfaces by a center seam; and a mechanism disposed along the center seam for preventing fluids generated during cooking from draining through the center seam.

In one embodiment consistent with the present invention, the center seam mechanism is a center grease drain wherein the center grease drain is incorporated with a portion of the body including one of the two cooking surfaces.

In another embodiment consistent with the present invention, the center seam mechanism is a silicone seal.

In yet another embodiment consistent with the present invention, the center seam mechanism is a ridge. The ridge is formed by an abutment of upwardly extending protrusions disposed along each edge of the center seam.

In another embodiment consistent with the present invention, a hinge is disposed at the center seam, which is operative to fold the cooking apparatus along the center seam, such that the two cooking surfaces are disposed on external opposite and parallel sides in the folded position.

In another embodiment consistent with the present invention, the two cooking surfaces are controlled by a control assembly. The control assembly is removably attached to the cooking apparatus, and an underside of the control assembly includes an attachment mechanism to receive and store the control assembly when not in use. The attachment mechanism includes a plurality of recesses formed in a body of the control assembly, and adapted to receive bosses formed in the underside of the body of the cooking apparatus.

In another embodiment consistent with the present invention, an indentation is formed in the body of the cooking apparatus, and in the two cooking surfaces, the indentation being adapted to receive the control assembly. The indentation can be of any shape which corresponds to the shape of the control assembly.

In another embodiment consistent with the present invention, the control assembly includes a body having a plurality of control elements, and a cover covering the control elements. The control elements may include at least one thermostatic control and a pilot light.

In another embodiment consistent with the present invention, the control assembly includes at least one connection mechanism which is inserted into a socket in the body of the cooking apparatus, to connect the control assembly to the griddle.

In another embodiment consistent with the present invention, the connection mechanism includes at least one probe which is connected to the thermostatic control.

In another embodiment consistent with the present invention, a second probe is connected to a second thermostatic control on the control elements, such that the two cooking surfaces are separately controlled.

In another embodiment consistent with the present invention, at least one drain is disposed in each of the two cooking surfaces, the drain which receives fluids generated on each of the two cooking surfaces. At least one aperture is disposed in the drain to drain the fluids accumulated therein, and at least one receptacle is disposed beneath the aperture, for collecting the fluids. The receptacle is removable and includes a securing mechanism to secure the receptacle to the body of the cooking apparatus. The securing mechanism is a detent detail in the receptacle which engages a spring tab in the body of the cooking apparatus.

In another embodiment consistent with the present invention, a plurality of heating elements are disposed in the body of the cooking apparatus and connected to the socket in which the connection mechanism of the control assembly is placed.

In another embodiment consistent with the present invention, a handle is disposed at opposite side surfaces of the two cooking surfaces.

In another embodiment consistent with the present invention, a closing mechanism is included with the body of the cooking apparatus, to hold the cooking apparatus closed when folded.

In one embodiment consistent with the present invention, the closing mechanism is a magnetic closure element, and in another embodiment consistent with the present invention, is a snap clip.

In one embodiment consistent with the present invention, a plurality of legs are disposed beneath the two cooking surfaces as a supporting mechanism to support the cooking apparatus.

In one embodiment consistent with the present invention, a plurality of projections stably support the cooking apparatus when folded for storage.

In another embodiment consistent with the present invention, a method of storing a cooking apparatus includes using a hinge at a center seam of the cooking apparatus to separate two cooking surfaces of the cooking apparatus; and folding the cooking apparatus such that said two cooking surfaces are on external opposite and parallel sides.

In another embodiment consistent with the present invention, the method includes storing a control assembly within the underside of the cooking apparatus prior to using the hinge to separate the two cooking surfaces.

Thus has thus been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a perspective view of a folding griddle, opened for use, according to one embodiment consistent with the present invention.

FIG. 2A is a perspective view of the center grease drain disposed below the center seam between the two halves of the folding griddle, according to one embodiment consistent with the present invention.

FIG. 2B is a schematic side view of the center grease drain of FIG. 2A.

FIG. 3 is a perspective view of an underside of the folding griddle, according to one embodiment consistent with the present invention.

FIG. 4 is a perspective view of the folding griddle according to one embodiment consistent with the present invention, showing the control assembly detached from the griddle, and the grease trays removed.

FIG. 5 is a top view of the folding griddle according to one embodiment consistent with the present invention, showing the cover of the control assembly open, and the grease trays open.

FIG. 6 is perspective rear view of the control assembly according to one embodiment consistent with the present invention.

FIG. 7 is a top view of the folding griddle showing grease channels and drain holes, according to one embodiment consistent with the present invention.

FIG. 8 is a perspective view of an underside of the folding griddle, showing the grease tray in detail, according to one embodiment consistent with the present invention.

FIG. 9 is a schematic side view of the folding griddle according to one embodiment consistent with the present invention, showing the ridge along the center seam.

FIG. 10A is a schematic side view of the folding griddle in a partially open position, according to one embodiment consistent with the present invention, showing a seal along the center seam.

FIG. 10B is a schematic side view of the folding griddle according to one embodiment consistent with the present invention, showing the seal along the center seam.

FIG. 11 is a side view of the folding griddle according to one embodiment consistent with the present invention, which shows the front of the griddle, and the legs on which the griddle is supported.

FIG. 12 is a perspective view of the folding griddle according to one embodiment consistent with the present invention, showing the griddle folded and ready for storage, including a snap clip closing mechanism.

FIG. 13 is a perspective view of the folding griddle according to one embodiment consistent with the present invention, showing the griddle folded and ready for storage.

FIG. 14 is a perspective view of the folding griddle, showing the sockets with terminal pins and hole for insertion of a probe, according to one embodiment consistent with the present invention.

### DETAILED DESCRIPTION OF THE INVENTION

The present invention relates to a cooking apparatus in the form of a folding griddle which provides the advantages of ease of use and of storage.

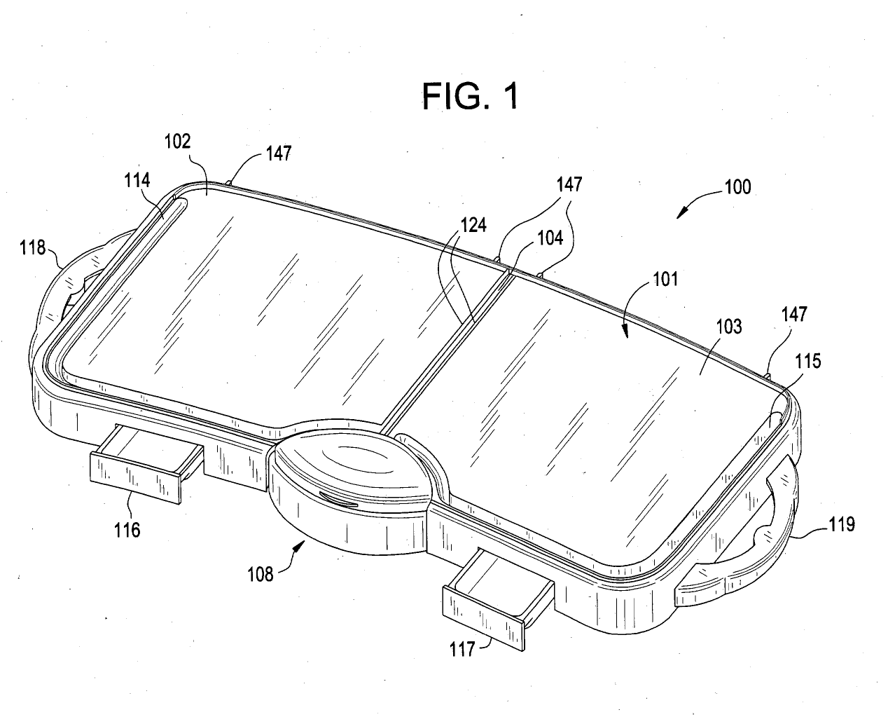

FIG. 1 depicts a perspective view of a folding griddle 100 consistent with the present invention, as it appears when ready for use by a user. The griddle 100, as shown in FIG. 1, is substantially rectangular in shape with curved edges, and allows uniform reach from a center position. However, the griddle 100 can have more angular edges or a square shape, if desired. In one embodiment consistent with the present invention, the body of the griddle 100 is cast from aluminum, but can be made of any material suitable for handling the cooking temperatures, and lightweight enough for easy handling.

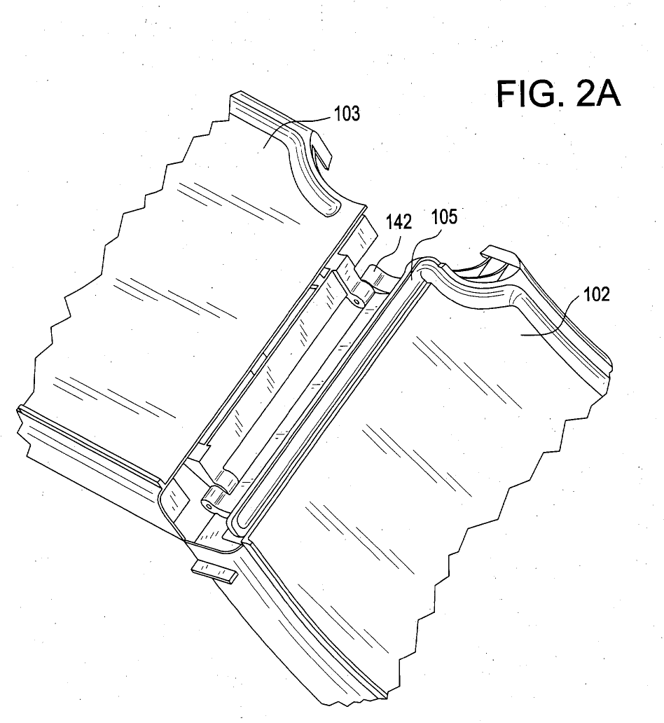

The griddle 100 includes a flat cooking surface 101, divided in half, into griddle surfaces 102 and 103 separated by a center seam 104. Beneath the center seam 104 is a center grease drain 105 (see FIG. 2) provided to enable a user to equally operate both halves 102, 103 of the griddle 100 without concern about cooking fluids accumulating and spilling over from the griddle surfaces 102, 103. The center grease drain 105 is a trough disposed under the center seam 104 between the two halves 102, 103 of the griddle. The center grease drain 105 is incorporated into the left griddle 102 casting, for example, and is disposed below the center seam 104 when the griddle 100 is in use. The center grease drain 105 receives oils, grease, and juices generated from foodstuffs being cooked on the griddle 100 such that cooking over the center seam 104 of the apparatus does not result in drainage of grease from the griddle 100 onto the surface on which the griddle 100 is placed.

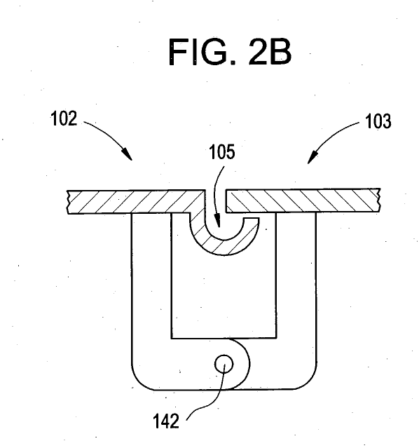

Each griddle half 102, 103 includes a tubular heating element 106, 107 disposed beneath the surface of the griddle halves 102, 103 (see FIG. 3) and disposed in grooves in the griddle body casting. The heating elements 106, 107 can be also be incorporated into the casting of the griddle body at that time, or can be welded into the surface 101 of the folding griddle 100.

The heating elements 106, 107 are used to heat the griddle surfaces 102, 103, and can take any shape as the heating means. The heating elements 106, 107 are controlled by a control assembly 108 (see FIG. 1) which are connected to the folding griddle 100 and disposed toward a front portion of the griddle 100 during use.

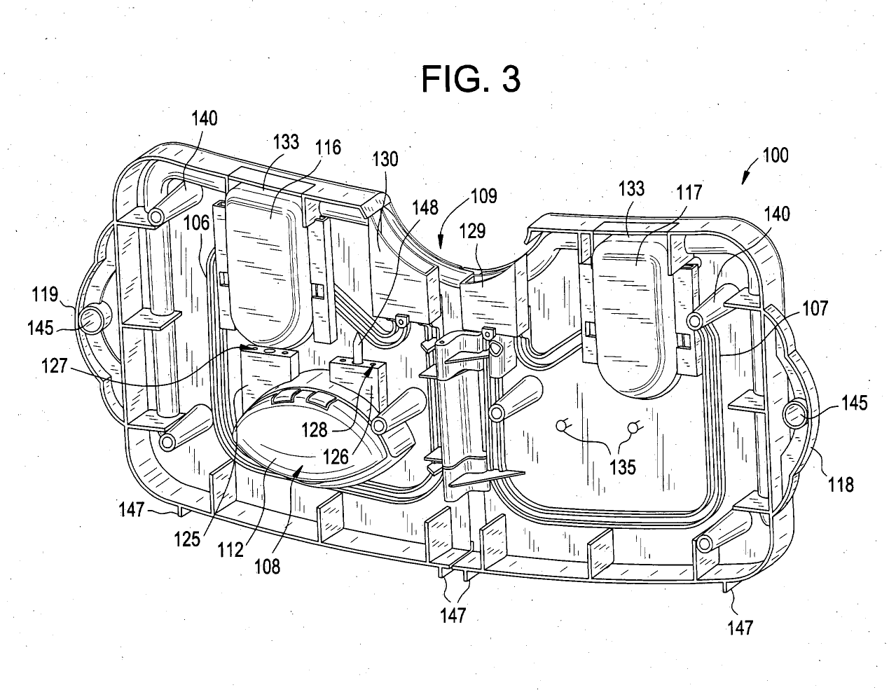

Specifically, the control assembly 108, in one embodiment consistent with the present invention, is substantially oval in shape and disposed in a semicircular indentation 109 (see FIG. 4) formed in the central portion of the griddle 100. However, the control assembly 108 can be of any shape and disposed in any correspondingly shaped indentation of the folding griddle 100. The control assembly 108 includes a power cord (not shown) which is attached to the assembly 108, and is attached to the griddle 100 and the heating elements 106, 107 via a connection mechanism or connection means, which includes two connectors 125, 126 (see FIG. 3) extending from a body of the control assembly 108. The connectors 125, 126, in one embodiment consistent with the present invention, each include a pair of female connectors 127, 128, that are inserted into sockets 130, 129 (see FIGS. 3-4) disposed underneath the folding griddle 100 at a front portion of the griddle 100. However, any other connection means can be used, such as a snap fit.

When the control assembly 108 is attached to the folding griddle 100 by the user, the user inserts the connectors 125, 126 into sockets 130, 129, respectively, and the electrical terminal/male connector pins 143, 144 which are disposed in the sockets 130, 129 and which are connected to heating elements 107, 106 at connections within the sockets 130, 129, are inserted into the female connectors 127, 128 such that the griddle 100 is powered and ready to operate.

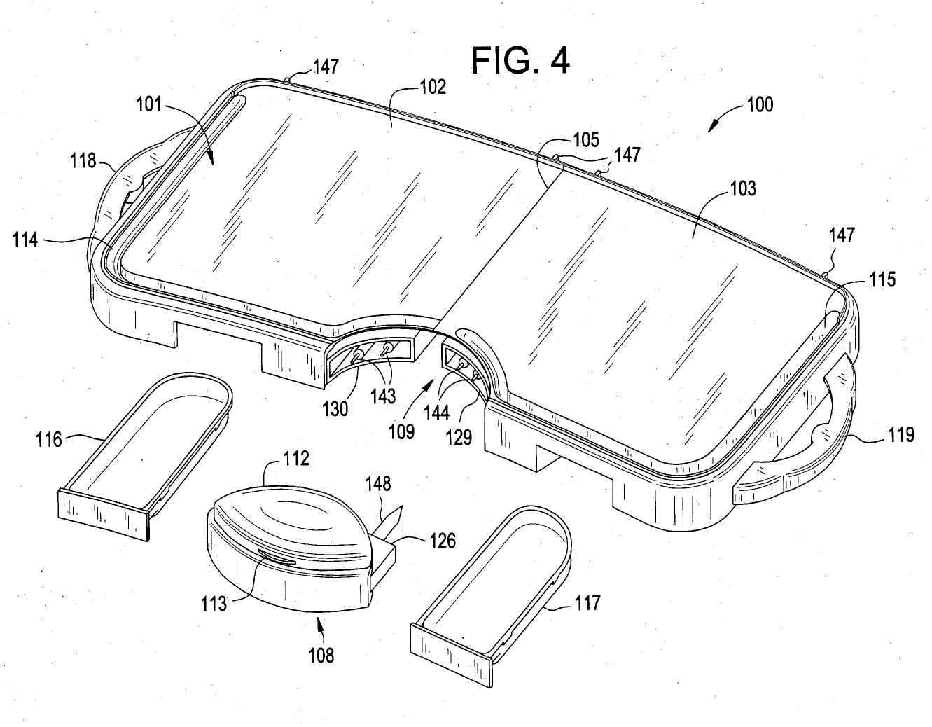

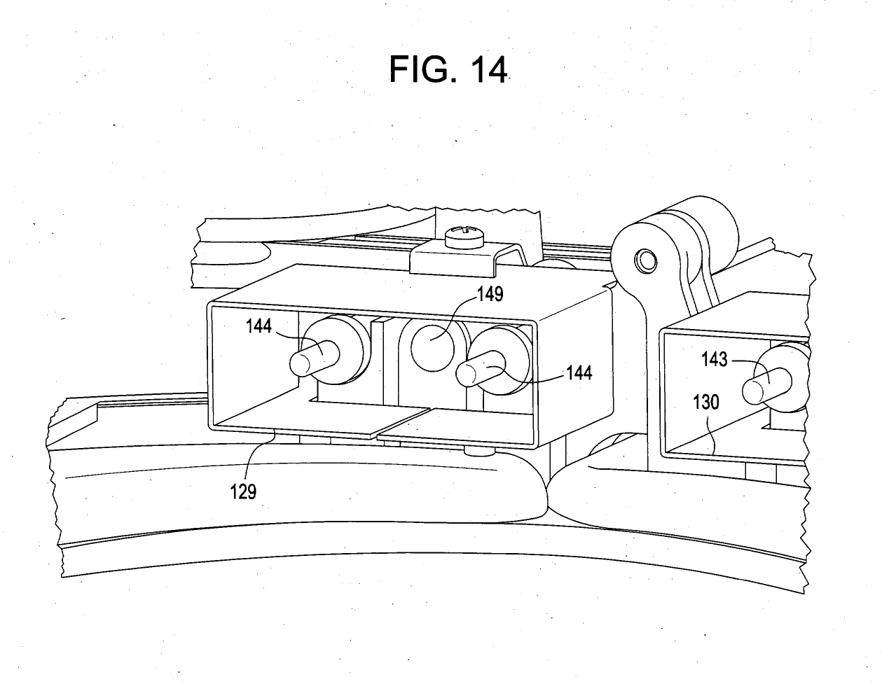

Further, in one embodiment consistent with the present invention, a cylindrical metal probe 148 is disposed in a center position (see FIG. 3) between the pair of female connectors 128 of connector 126, and extends approximately 2-3 inches to a tapered tip, and acts as a temperature sensing device. The probe 148 is inserted into a hole 149 between male connector pins 144 in socket 129 (see FIGS. 4 and 14), and directly into the casting of the griddle body. The probe 148 is a one piece thermostat which is directly connected to a thermostatic control 110 (see FIG. 5) which provides temperature control for the griddle surfaces 102, 103. The thermostatic control or thermostat 110 may vary from 250° to 400° F., for cooking.

In one embodiment consistent with the present invention, the control elements in the control assembly 108 may include, in addition to the thermostatic control 110, an on/off switch and a pilot light 111 which may be provided to advise the user that the griddle 100 is turned on and has a hot surface 101.

Thus, in this embodiment consistent with the present invention, dual pilot lights 111 are provided, to allow the user to separately cook different items on each surface 102, 103 of the griddle 100, rather than to make both griddle surfaces 102, 103 the same temperature to cook one large item.

The control assembly 108, as shown in FIG. 5, includes a dome-like cover 112, which may be transparent, disposed over the control elements, which keeps cooking fluids and/or grease splatter off the control elements. The user may see the control elements and the temperature settings of the thermostat 110 for the griddle surfaces 102, 103 through the cover 112 without exposing the control elements to damage by cooking fluids.

In one embodiment consistent with the present invention, the cover 112 is hinged and opened by the user by manipulating a small protrusion 113 on the cover 112 (see FIG. 5). However, in other embodiments, any other type of means can be used to removably attach the cover 112 to the control assembly 108 (i.e., snap-fit etc.), or the control assembly 108 can be separate from the griddle 100 itself as long as it is connected to the heating elements 106, 107 by a connection means, such as a power cord.

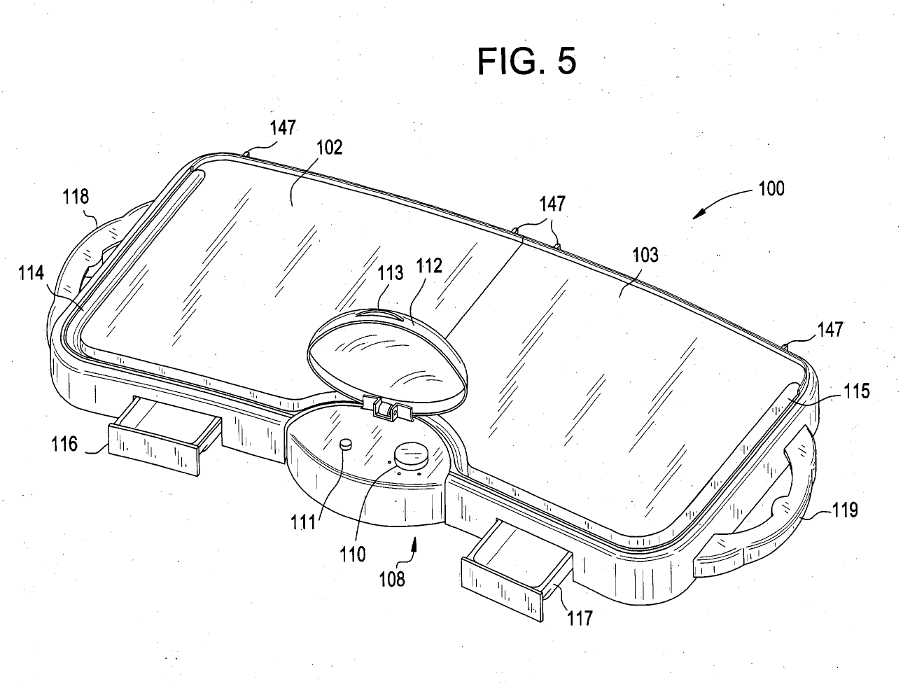

In one embodiment consistent with the present invention, the control assembly 108 can be detached from the griddle 100 and stored beneath the griddle 100 as shown in FIG. 3, when the griddle 100 is not in use. The control assembly 108 is attached to the griddle 100 by an attachment mechanism (see FIG. 6) which is used to hold the control assembly 108 in place when mounted on the underside of the griddle 100. The attachment mechanism or means includes recesses 134 in the surface of the underside of the control assembly 108, the recesses 134 which would fit into bosses 135 projecting from the underside of the griddle 100. However, other attachment mechanisms can be used, such as a storage compartment.

Each griddle surface half 102, 103 includes a trough or drain channel 114, 115 as a drain, cast at a periphery of the griddle surfaces 102, 103, at a front and at sides of the griddle surfaces 102, 103. However, in other embodiments consistent with the present invention, the drain channels 114, 115 can be disposed at an entire periphery, or at other locations and in different patterns, of the griddle surfaces 102, 103.

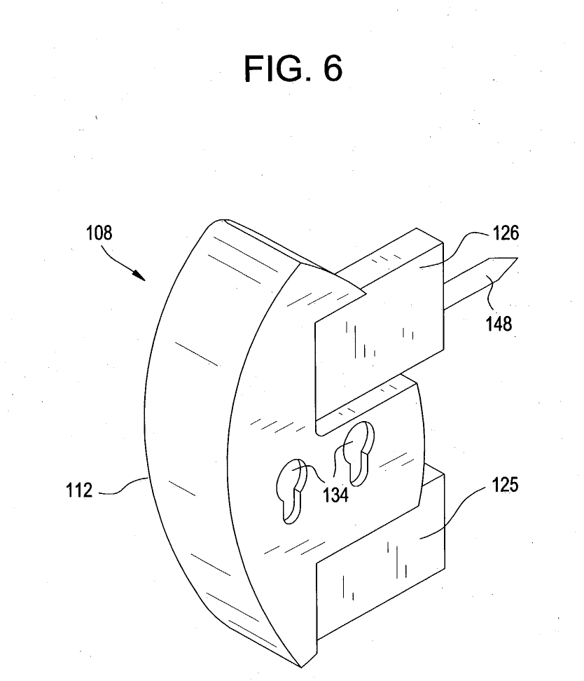

As shown in FIG. 7 there is at least one drain hole or aperture each (see drain holes 136, 137) disposed in the drain channels 114, 115 for the fluids or grease generated during cooking to flow into the drain channels 114, 115 instead of overflowing over the griddle 100. The fluids and grease can spill from the surfaces 102, 103 into the drain channels 114, 115, and flow through the drain holes 136, 137 into the receptacles or grease trays 116, 117 (see FIG. 1) disposed below the griddle 100, to collect there for later removal by the user.

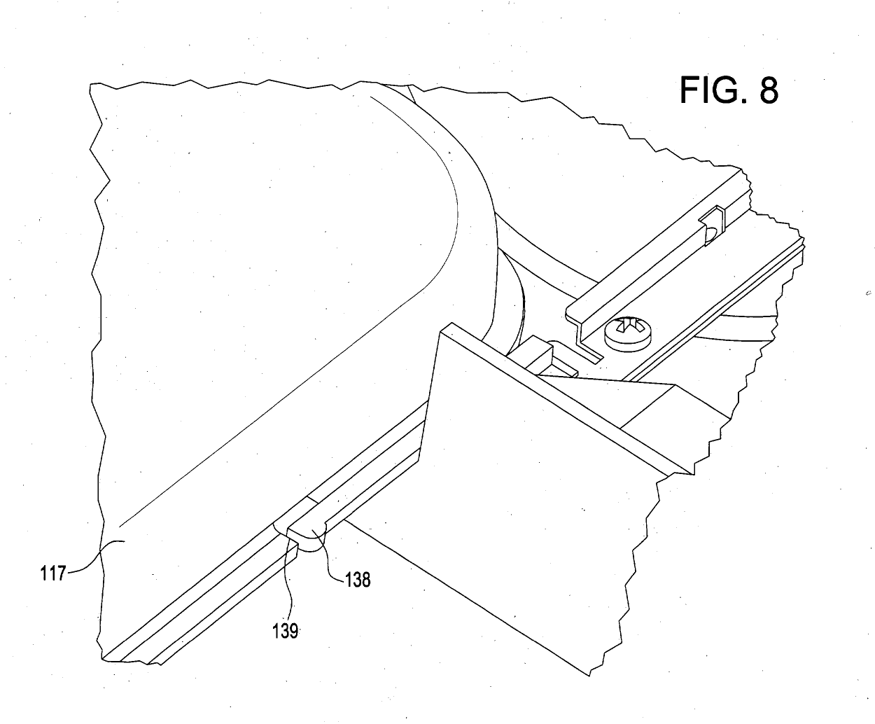

In other embodiments consistent with the present invention, other mechanisms can be used to assist in the drainage of grease and fluids from the cooking surfaces 102, 103 to the drain channels 114, 115. For example, instead of the center grease drain 105, a ridge 124 (see FIGS. 1 and 9) can be disposed down the center seam 104 (see FIG. 1), formed by an upwardly extending protrusion on both of the griddle surfaces 102, 103 (see FIG. 9), such that the cooking fluids generated during griddle use, are kept away from the center seam 104 and collected by the drain channels 114, 115 for drainage via the drain holes 136, 137 into the grease trays 116, 117.

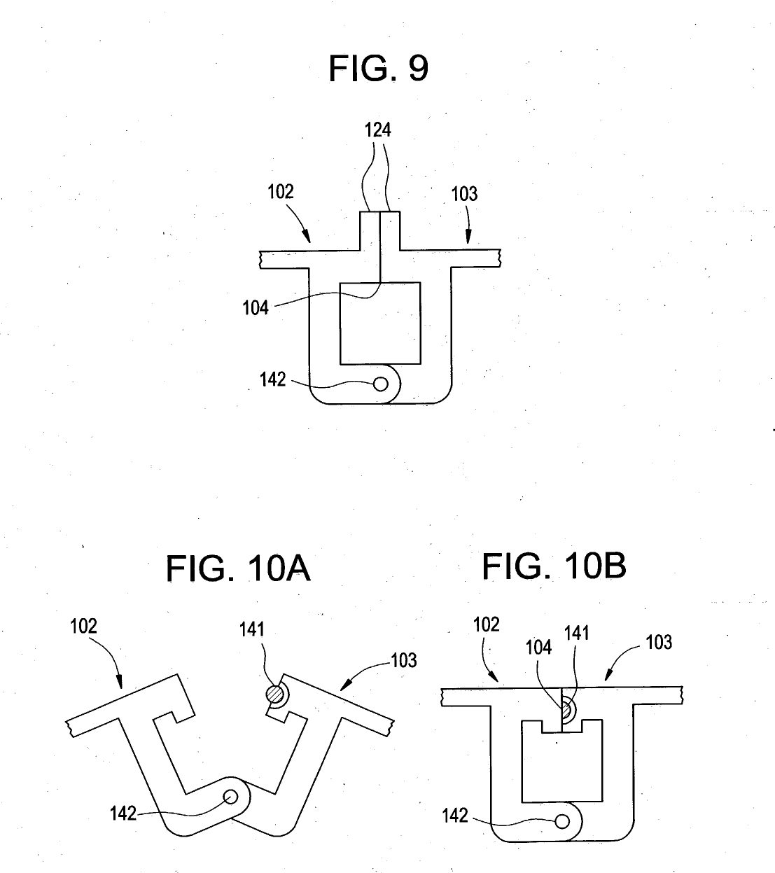

In yet another embodiment consistent with the present invention as shown in FIGS. 10A-10B, a gasket seal 141 can be used instead of the center grease drain 105. In this embodiment, the seal 141 is disposed in a longitudinal groove in surface 103 of the two surfaces 102, 103 of the body of the griddle 100 along the center seam 104 (see FIG. 10A). In this embodiment, the seal 141, which is made of silicone or any other suitable material able to withstand high temperatures and which is flexible, protrudes from the groove in the center seam 105. When the griddle 100 is closed using the hinge 142 (see FIG. 10B), the seal 141 is compressed against the other griddle surface 102, such that it forms a seal at the center seam 104 and prevents and grease or other fluids draining through the center seam 104 below the griddle surface 101—forcing the grease and fluids into the drain channels 114, 115.

However, in other embodiments consistent with the present invention, the position, size, and number of drain channels, drain holes, and ridges, and the shape and location of the grease trays, can differ, and other grease drainage mechanisms such as extra grease channels, can be used, as long as the grease is appropriately drained from the griddle surfaces 102, 103.

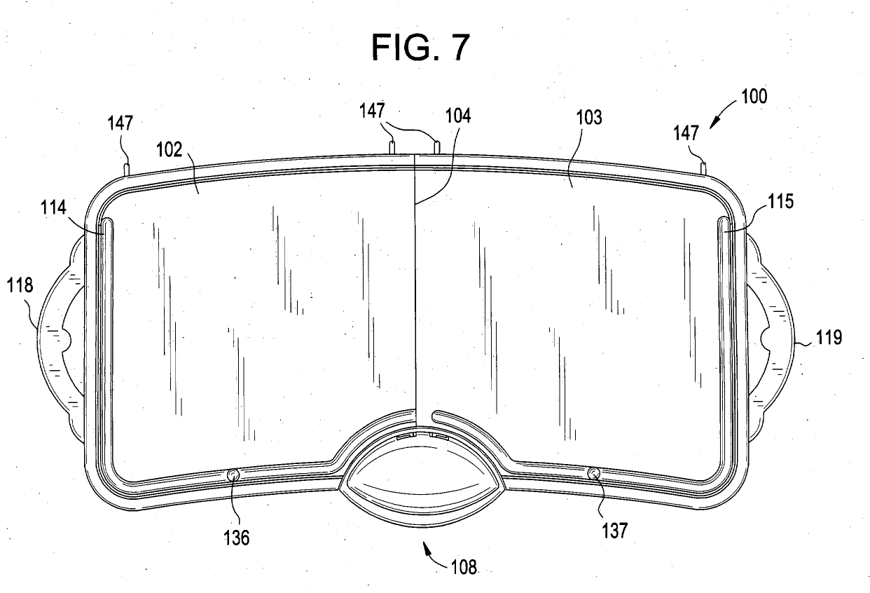

In one embodiment consistent with the present invention, the grease trays 116, 117 are substantially rectangular in shape and are designed as pull-out drawers disposed in the front portion of the griddle 100 (see FIG. 4). The grease trays 116, 117 are held in place in the griddle 100 by a securing mechanism which is a molded spring tab 138 (see FIG. 8) which engages the detent detail 139 in the grease tray 116 or 117. Thus, the trays 116, 117 do not fall out of the body of the griddle 100 when the griddle 100 is folded.

During use, the user may manipulate a lip 133 (see FIG. 3) at the underside of the tray 116 or 117 to pull the grease trays 116 or 117 forward as shown in FIG. 1, until the spring tab 138 engages to prevent further forward movement, in order to determine if the trays 116, 117 are full of grease and cooking fluids, and need to be cleaned. The trays 116, 117 are completely removable from the griddle 100, and can be cleaned and replaced for the next usage by manipulating the spring tab 138 to release the trays 116, 117.

In one embodiment consistent with the present invention, the grease trays 116, 117 can be made of polypropylene which is easy to clean, but can be made of any material which can collect hot fluids without degradation and warping, and which is easy to clean.

Handles 118, 119, which are curved in one embodiment (see FIG. 1), but which can be of any shape as long as they can be gripped securely by the user, are disposed at each side of the folding griddle 100, to assist the user in placing the griddle 100 at an appropriate location on a surface. Like the grease trays 116, 117, the handles can be made of polypropylene, but can be made of any material which is able to handle the weight of the griddle 100 and can be easily molded to the desired shape.

In fact, the body of the control assembly 108 with connectors 125, 126, and the sockets 129, 130 are also made of polypropylene, but can be made of any other suitable material. If necessary, thermal insulation can be added to the supporting structures of the griddle 100, such as the sockets 129, 130, the grease trays 116, 117, and the body of the control assembly 108, in order to handle the temperatures reached during cooking (i.e., in the 115° C. range).

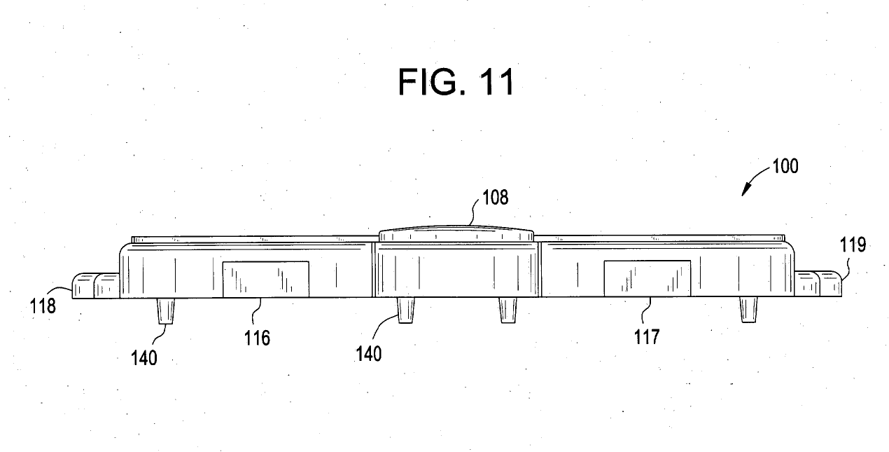

In one embodiment consistent with the present invention, legs 140 (see FIGS. 3 and 11) have been added to the underside of the folding griddle 100 housing as a supporting mechanism to provide a support for the griddle 100 when in use. However, the supporting mechanism can be of any shape and size which are appropriate for use of the griddle 100.

When the user is no longer using the griddle 100 for cooking, the griddle 100 can be folded in half for compact storage. First, once cooking has been completed, the griddle 100 turned off, the grease trays 116, 117 cleaned and replaced, and the griddle 100 has cooled, the control assembly 108 is detached from the griddle 100 by the user by removing the connectors 125, 126 from the sockets 130, 129. Then, the user can grasp the handles 118, 119 to turn the griddle upside down, with the underside facing upward (see FIG. 3). Once upside down, the power cord (not shown), which delivers power to the griddle 100, is removed from the control assembly 108, and wrapped around the control assembly 108 or disposed in other openings in the underside of the griddle 100 for storage. Other storage means, such as a storage compartment (not shown), can be used.

The control assembly 108 is disposed in a predetermined position underneath the griddle 100. As stated previously, the control assembly 108 is attached to the griddle 100 by an attachment mechanism to hold the control assembly 108 in place when mounted on the underside of the griddle 100. However, other attachment mechanisms, or storage means, such as a storage compartment, can be used.

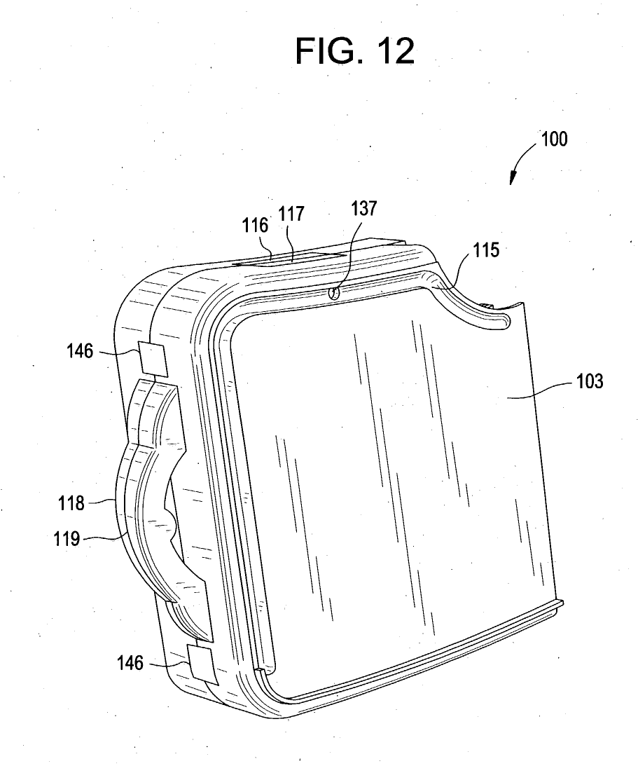

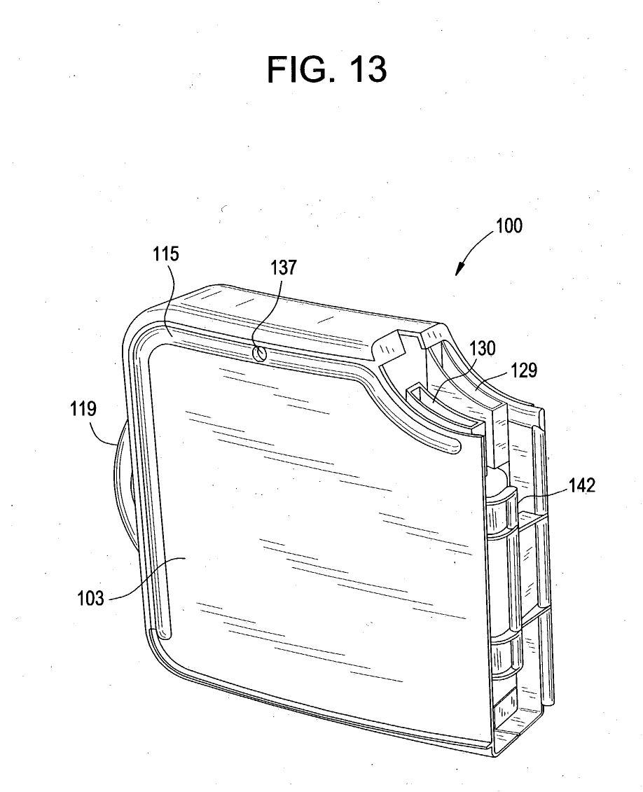

Thus, the control assembly 108 and power cord, and any other peripheral equipment, such as a separate temperature sensing device, can be stored with the folding griddle 100 such that they are not misplaced. Further, when the griddle is folded, as shown in FIGS. 12-13, the control assembly 108 and power cord are disposed inside the folded griddle 100, and cannot be lost. Further, the molded spring tab 138 prevents the grease trays 115, 117 from falling out of the griddle 100.

Accordingly, once the control assembly 108 and power cord are stored, the griddle 100 is folded in half by being grasped at the handles 118, 119 and rotated and folded along the center seam 104 by hinge 142 (see FIG. 13). When folded, the griddle surfaces 102, 103 are disposed on external opposite and parallel sides (see FIGS. 12-13), and the griddle 100 can be carried by the user by grasping the handles 118, 119 which are disposed in abutment to one another.

A magnetic closure element 145 (see FIG. 3) holds the folding griddle 100 in a closed and folded position. The magnetic closure element 145 is used to the keep the folding griddle 100 closed when stored, and can be disposed in the handles 118, 119, or can be disposed in the body of the griddle 100 itself proximate to the handles 118, 119, on the underside of the folding griddle 100. In another embodiment consistent with the present invention, another closing mechanism can be used, including a snap clip 146 disposed at any position external to the body of the griddle 100 (see FIG. 12, for example).

The griddle 100 is preferably stored on its side for ease of storage and removal from shelves. Projections 147 or ribs, are added to the body of the griddle along one side surface to balance the griddle stably when stored (see FIGS. 3 and 12).

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

1. A cooking apparatus comprising:
a body having a substantially planar cooking surface heated by a heating mechanism and divided into two cooking surfaces by a center seam, wherein said cooking apparatus is foldable along said center seam; and
a mechanism disposed along said center seam for preventing fluids generated during cooking from draining through said center seam.

2. The cooking apparatus according to claim 1, wherein said center seam mechanism is a center grease drain.

3. The cooking apparatus according to claim 1, wherein said center seam mechanism is a seal.

4. The cooking apparatus according to claim 1, wherein said center seam mechanism is a ridge.

5. The cooking apparatus according to claim 2, wherein said center grease drain is incorporated with a portion of said body including one of said two cooking surfaces.

6. The cooking apparatus according to claim 3, wherein said seal is made of silicone.

7. The cooking apparatus according to claim 4, wherein said ridge is formed by an abutment of upwardly extending protrusions disposed along each edge of said center seam.

8. The cooking apparatus according to claim 1, further comprising a hinge at said center seam, which is operative to fold the cooking apparatus along said center seam, such that said two cooking surfaces are disposed on external opposite and parallel sides.

9. The cooking apparatus according to claim 1, further comprising a control assembly, and said two cooking surfaces are controlled by said control assembly.

10. The cooking apparatus according to claim 9, wherein said control assembly is removably attached to the cooking apparatus.

11. The cooking apparatus according to claim 9, wherein said body of the cooking apparatus includes an underside, and wherein said underside includes an attachment mechanism to receive and store said control assembly when not in use.

12. The cooking apparatus according to claim 9, further comprising an indentation formed in said body, and in said two cooking surfaces, said indentation being adapted to receive said control assembly.

13. The cooking apparatus according to claim 9, wherein said control assembly includes a body having a plurality of control elements, and a cover covering said control elements.

14. The cooking apparatus according to claim 13, wherein said control elements include a first thermostatic control.

15. The cooking apparatus according to claim 14, further comprising a first connector disposed on said control assembly.

16. The cooking apparatus according to claim 15, further comprising a first probe disposed on said first connector, said first probe which is connected to said first thermostatic control.

17. The cooking apparatus according to claim 13, wherein said control elements include a pilot light.

18. The cooking apparatus according to claim 9, wherein said two cooking surfaces are separately controlled.

19. The cooking apparatus according to claim 16, further comprising:
a second connector disposed on said control assembly and having a second probe disposed thereon; and
wherein said control elements include a second thermostatic control; and
wherein said second probe is connected to said second thermostatic control.

20. The cooking apparatus according to claim 19, wherein said two cooking surfaces are separately controlled by said first thermostatic control and said second thermostatic control.

21. The cooking apparatus according to claim 11, wherein said attachment mechanism includes a plurality of recesses formed in a body of said control assembly, and adapted to receive bosses formed in said underside of said body of the cooking apparatus.

22. The cooking apparatus according to claim 1, further comprising at least one drain disposed in each of said two cooking surfaces, said drain for receiving fluids generated on each of said two cooking surfaces.

23. The cooking apparatus according to claim 22, further comprising at least one aperture disposed in said drain to drain said fluids accumulated therein.

24. The cooking apparatus according to claim 23, further comprising at least one receptacle disposed beneath said aperture, for collecting said fluids.

25. The cooking apparatus according to claim 24, wherein said receptacle is removable.

26. The cooking apparatus according to claim 25, wherein said receptacle includes a securing mechanism to secure said receptacle to said body of the cooking apparatus.

27. The cooking apparatus according to claim 26, wherein said securing mechanism is a detent detail in said receptacle which engages a spring tab in said body of the cooking apparatus.

28. The cooking apparatus according to claim 19, further comprising a socket disposed in said body of the cooking apparatus, adapted to receive each said connector.

29. The cooking apparatus according to claim 28, further comprising a plurality of heating elements disposed in said body of the cooking apparatus and connected to said control assembly via a connection mechanism to said socket.

30. The cooking apparatus according to claim 1, further comprising a handle disposed at opposite side surfaces of said two cooking surfaces.

31. The cooking apparatus according to claim 1, further comprising a closing mechanism disposed within said body of the cooking apparatus, to hold the cooking apparatus closed when folded.

32. The cooking apparatus according to claim 31, wherein said closing mechanism is a magnetic closure element.

33. The cooking apparatus according to claim 31, wherein said closing mechanism is a snap clip.

34. The cooking apparatus according to claim 1, further comprising a supporting mechanism to support the cooking apparatus during usage.

35. The cooking apparatus according to claim 1, further comprising a plurality of projections which stably support the cooking apparatus when folded for storage.

36. A griddle comprising:
a griddle body having a substantially planar cooking surface heated by a heating mechanism and divided into two cooking surfaces by a center seam; and
a hinge disposed along said center seam to separate said two cooking surfaces such that the griddle can be folded in half and said two cooking surfaces can be disposed at external opposite and parallel sides.

37. A method of storing a cooking apparatus comprising:
using a hinge at a center seam of the cooking apparatus to separate two cooking surfaces of the cooking apparatus; and
folding the cooking apparatus such that said two cooking surfaces are on external opposite and parallel sides.

38. The method according to claim 37, further comprising:
storing a control assembly within the underside of the cooking apparatus prior to using said hinge to separate said two cooking surfaces.
